(19) United States
(12) Patent Application Publication
(10) Pub. No.: US 2011/0133482 A1
(43) Pub. Date: Jun. 9, 2011

(54) SYSTEM AND METHOD FOR PRODUCTION OF ELECTRICITY IN SMALL/LARGE SCALE IN AN ECO-FRIENDLY MANNER WITHOUT USAGE OF ANY RAW MATERIALS

(75) Inventor: Surinder Singh Parmar, Rourkela (IN)

(73) Assignee: Surinder Singh Parmar, Rourkela, OR (IN)

(21) Appl. No.: 13/058,730

(22) PCT Filed: Aug. 18, 2009
(86) PCT No.: PCT/IN2009/000457

§ 371 Date: Feb. 11, 2011

(30) Foreign Application Priority Data
Aug. 21, 2008 (IN) 1404/KOL/2008

(51) Int. Cl. H02K 7/18

(52) U.S. Cl. 290/1 A

(57) ABSTRACT

A scalable technique for generation of electricity where at least one moving machine is connected with at least one rotatable circular moving arm. The circular moving arm is supported with respect to a vertical gear shaft positioned in a bearing gear housing. Two ends of the moving arm are adapted to be freely rotated in a circular path causing rotation of the vertical shaft. At least one alternator(s)/generator(s) is operatively connected to said vertical shaft such that rotation of the vertical shaft causes the alternator/generator to generate electricity.

### FIELD OF THE INVENTION

The present invention relates to a system for generation of electrical energy by conversion of mechanical form of energy without consuming any natural conventional or non-conventional form of fuel or other form of energy known in the art. More particularly, the present invention is directed to a system for generation of electrical energy by conversion of mechanical energy in the form of inertial mass momentum or kinetic energy of moving body, in a cost effective and environment friendly manner. The system of the present invention involves conversion of circular motion of a pair of bodies e.g. cars/trolley on wheels such that they deliver the kinetic energy or mass momentum of bodies in motion through 360° in horizontal plane, to the horizontal arm to which they are connected at either diametric end of circular path, provide rotary motion to a shaft vertically disposed at the center of said circular path of the moving bodies/trolleys and said vertical shaft connected selectively through a plurality of gear arrangements and drive shafts operatively to drive any one or both of a pair of alternator adapted to deliver commensurate electrical energy at out put/to external load. The gear assembly and mountings including bearing supports for shafts and other mountings for elements of the system in motion, are configured to consume negligible power developed by the system so that, even if the system need/consume power from external source at the starting/initiation of motion, it is capable of providing, uninterrupted electrical energy at the output of alternators coupled to said mechanical system. The device according to the present invention is adapted to be suitably scaled up to developing electrical energy in the range from 1 kW to up to 60 MW. The system and the method for developing electrical energy from mechanical energy in the form of momentum of bodies in motion or the kinetic energy of rotating masses is thus adapted to conserve natural energy resources, protect environment free of any pollution generation, low cost and manpower intensive having potential for wide scale application in micro and medium scale power generating stations using limited land resource to meet the ever increasing demand of the electrical energy as a new viable alternative to conventional source of energy saving scarce resources.

### BACKGROUND OF THE INVENTION

It is known in the art of electrical power generation that since the invention of electricity way back over centuries, it has been accepted as a most useful form of energy for use by the mankind for every walk of life and desired progress of human civilization and improved living/work conditions. Whether in domestic front or industrial application, there has been accelerated demand for electrical energy for the society to sustain scientific inventions and application of newer technologies, means of mechanized agriculture/farming, transport, various drive systems, irrigation/industrial pumps, heating-ventilation & air conditioning, electronics and computers or the like—all depending largely on availability of electrical energy. There is no denying the fact that energy is a basic requirement for economic development in every sector of the National economy. The economic development plans implemented since independence have necessitated increasing amount of energy inputs. As a result, consumption of energy in all form has been steadily rising all over the country as well as globally. It has thus been a simultaneous effort to reduce consumption of electrical power by energy efficient devices to restrain the trend of demand for electricity.

Also with the increased rate of population and growth oriented living standard it developing countries, there has been more reliance on electrical power consuming devices and appliances is growing and thus requiring large scale augmentation of power generation capacities. Efforts are on since last few, decades to replace conventional fossil fuel powered as well as nuclear powered electrical energy generation to protect environment from pollution and avoid health hazards by way of toxic effluents disposal/emissions. The wind power, hydel power, solar power, bio-gas plants, fuel from organic wastes to generate electrical power, tidal power etc. has been successfully implemented to save depletion of natural reserve of resources e.g. coal, petroleum and other radioactive sources naturally available but in limited scale used to develop steam based power, nuclear power, gas turbine power and such other conventional forms of electricity generation means. But such non-conventional sources are on one hand costly per unit power generation and on the other hand substantially high initial investments involving long gestation period for installation and operation needing more space and manpower. They also suffer from limitations like the availability and abundance of water reservoirs at desired altitude, requirements of building dams, continuous and sufficient flow and velocity of wind to derive wind power economically justifying plant installation in any geographical location, viability of transmission of electrical power to nearest grid, to reach to the consumers, availability of enough intensity of solar radiation throughout the year etc. Off-late, efforts are on to explore the possibility of exploiting the geo-thermal energy to drive steam based turbo-alternators to develop electrical power. Thus it has been a continuous need in the existing art to develop alternative electrical power generating devices/systems by economical and eco-friendly manner at low cost using less space and manpower and avoiding reliance on conventional/natural resources, adapted to meet the growing demand of electrical power. It has been experienced in the art that it is generally the conversion of energy of any one of the forms of energy such as the heat, light, nuclear, chemical and potential energy etc. is implemented to much desired electrical form of energy required to meet the domestic, industrial and other demands. The present invention seeks to achieve conversion of simple mechanical form of energy as momentum or kinetic energy based input to any system for generation of electrical form of energy, that largely remained unexplored till now, to make electricity available for consumption at less cost and environment friendly manner in commercial scale.

### OBJECTS OF THE INVENTION

The basic object of the present invention is thus directed to developing a system for generation of electrical energy by conversion of mechanical form of energy and particularly change in mass momentum and or kinetic energy of moving bodies, at less cost of per unit power developed in a simple, reliable, cost effective and environ friendly manner.

Another object of the present invention is directed to developing a system for conversion of kinetic energy based mechanical form of energy to electrical energy to economically produce 1 kW to 60 Mw power in commercially viable form.

A further object of the present invention is directed to developing a system for conversion of kinetic energy based mechanical form of energy to electrical energy to save conventional scarce natural resources generally used for electricity generation and to avoid limitations on availability of such resources inducing prohibitive costs.

A still further object of the present invention is directed to developing a system for conversion of kinetic energy based mechanical form of energy to electrical energy in order to protect the environment from pollution by avoiding generation of damaging/toxic effluents/emissions from the system and thus ensuring clean energy, at par with existing wind, solar or hydro-electric power, at much less cost involving simple method of operation of said system.

A still further object of the present invention is directed to developing a system for conversion of kinetic energy based mechanical form of energy to electrical energy wherein the plant and equipments can be suitably configured and scaled up to small, medium or large capacities to meet the load demand.

A still further object of the present invention is directed to developing a system for conversion of kinetic energy based mechanical form of energy to electrical energy wherein plant and machineries used are at much less initial costs as compared to conventional captive coal/steam or other fuel based power plants.

A still further object of the present invention is directed to developing a system for conversion of kinetic energy based mechanical form of energy to electrical energy wherein maintenance infrastructure required consume only about 20% of the costs involvement having minimum cost of spares for maintaining traditional form of power plants.

A still further object of the present invention is directed to developing a system for conversion of kinetic energy based mechanical form of energy to electrical energy wherein the requirement of land area would be much less amounting to about 20% of the requirements for installation of conventional captive power plants.

A still further object of the present invention is directed to developing a system for conversion of kinetic energy based mechanical form of energy to electrical energy wherein the manpower requirement for operation and maintenance would be much less and is of the order of about 60% less than the deployment of manpower in traditional power plants.

A still further object of the present invention is directed to developing a system for conversion of kinetic energy based mechanical form of energy to electrical energy the plant can be installed irrespective of any geographical or climatic limitations or availability of water in abundance, as experienced in existing steam power, wind power, solar power, hydel power or tidal wave power based electrical power generating units/stations.

A still further object of the present invention is directed to developing a system for conversion of kinetic energy based mechanical form of energy to electrical energy that ensure no adverse effect on earths climate and natural balance in respect of bio-diversity.

A still further object of the present invention is directed to developing a system for conversion of kinetic energy based mechanical form of energy to electrical energy that is simple, safe and having longer operating life span.

### SUMMARY OF THE INVENTION

The basic aspect of the present invention is directed to a system for beneficial generation of electrical energy by conversion of mechanical/other form of energy comprising:
at least one rotatable circular moving arm supported with respect to a vertical shaft with bearing gear housing such that the two ends of the moving arm are adapted to be freely rotated in a circular path causing rotation of the said vertical shaft;
at least one alternator/generators operatively connected to said rotary vertical shaft whereby the rotation of the rotatable circular moving arm provides for required rotary motion at the said alternator/generators to generate electrical power;
said operative connection of the rotary verticals shaft with said alternator/generators comprising of speed-improving gear means;
said rotatable circular moving arm having selective length/radii such as to operate said alternator/generator of defined capacity and numbers such that with reduced input mechanical or other power source due to the selective contributory dimension of the rotatable arm the power generated at the alternators/generators are power and performance efficient.

The other forms of energy input comprise mechanical/electrical/fuel or manual and the like energy sources for conversion to/generation of electrical form of energy.

A further aspect of the present invention is directed to a system for beneficial generation of electrical energy by conversion of mechanical/other form of energy wherein said circular moving arm is operatively adapted at its free ends with the moving machine trolley/cars adapted to provide the required mass momentum or kinetic energy to a drive shaft to transmit input power for conversion to electrical energy to alternators through transmission gear-shaft arrangements.

A still further aspect of the present invention is directed to said system for beneficial generation of electrical energy by conversion of mechanical/other form of energy wherein the moving machine connected to the alternators comprise the following main components—(a) moving machine comprising wheeled cars/trolleys with drive motor and gear box adapted to receive power from external source or part of generation by the own system; (b) Horizontal Circular moving arm; (c) Vertical gear shaft; d) Crown gear, (e) Gear housing; (f) Horizontal shaft; (g) Speed controller gear Box; and (h) Generator/Alternator.

A still further aspect of the present invention is directed to said system for beneficial generation of electrical energy by conversion of mechanical/other form of energy wherein the moving machines comprise of vehicle/trolley having motor, with gear box, steel wheel/tyres and have means for controlling the speed of the moving vehicle.

A still further aspect of the present invention is directed to said system for beneficial generation of electrical energy by conversion of mechanical/other form of energy wherein The trolleys moving on the circular path, rotate the horizontal arm through 360° either clockwise or anticlockwise.
A still further aspect of the present invention is directed to said system for beneficial generation of electrical energy by conversion of mechanical/other form of energy comprising two or more moving machine operatively connected with moving trolleys on both end of respective horizontal rotating arms, the motor capacity/rating of cars/trolleys depending on capacity of alternator/generator.
A still further aspect of the present invention is directed to said system for beneficial generation of electrical energy by conversion of mechanical/other form of energy wherein for starting the moving machine, first external power is provided in the form of electricity/other form of energy including manual and once operation start up the system is adapted to generate power cost-effectively.
A still further aspect of the present invention is directed to said system for beneficial generation of electrical energy by conversion of mechanical/other form of energy wherein the horizontal arm is obtained having dimensions to ensure required strength and function and wherein the length of the horizontal arm determines the power advantage generated by the system such that if length is more, less force or power for moving would be required to provide required power to the vertical shaft and main gear drive systems.
A still further aspect of the present invention is directed to said system for beneficial generation of electrical energy by conversion of mechanical/other form of energy wherein the vertical gear shaft is connected with big crown gear wheel or gear housing and shaft top head which is above the main gear box/gear housing and also with the horizontal moving/rotating arm, the diameter of shaft may be different as per requirement depends on load and it can be made of any kind of metal or any size fitted/connected to main crown gear housing in vertical position and with bearings.
A still further aspect of the present invention is directed to said system for beneficial generation of electrical energy by conversion of mechanical/other form of energy wherein the crown gear is bigger in diameter having a ratio of 1:10 or more, as compared to other gear assembly in main gear housing and is fitted with bearing and chuck nuts, the vertical shaft with crown gear is supported on bearing, preferably cone bearing so that there occurs no tightness/center line out at the time of operation and it rotates freely along with other meshing gears in the gear box.
A still further aspect of the present invention is directed to said system for beneficial generation of electrical energy by conversion of mechanical/other form of energy comprising providing two crown gear wheel/gear wheel mirror type at a time, or only one depending on user requirement such that when it rotates with vertical gear shaft it gives rotation to its other connected smaller gear assembly in gear housing/main gear box which in turn provide drive power to the alternators/generators in the system.
A still further aspect of the present invention is directed to said system for beneficial generation of electrical energy by conversion of mechanical/other form of energy comprising gear housing obtained of any metal and is of required size and shape preferably selected from round, square, hexagon adapted to provide one, two and more horizontal shaft along with additional small speed controller gear boxes assembly or more for alternator/generator in higher numbers with the gear housing fitted with foundation bolt.
A still further aspect of the present invention is directed to a system for beneficial generation of electrical energy by conversion of mechanical/other form of energy wherein the Generators/Alternators are flexible and adapted for generating electricity on a small scale, smaller size of equipment, machinery and generator are used of appropriate ratings and for higher electricity generation capacities the equipment, machinery and generator/alternator comprise heavy duty devices.
A still further aspect of the present invention is directed to said system for beneficial generation of electrical energy by conversion of mechanical/other form of energy wherein said main gear box is adapted to have more then one horizontal driving shaft as per requirement, and thus more than two alternator/generator can be connected at a time to it, to produce electricity.

The present invention and its objects and advantages are described in greater details with reference to the following accompanying non limiting illustrative figures and exemplary embodiments.

### BRIEF DESCRIPTION OF THE ACCOMPANYING FIGURES

FIG. 1: is the schematic illustration of an embodiment of the system according to the present invention showing the front view of the system wherein the moving machine trolley/cars adapted to provide the required mass momentum or kinetic energy to a drive shaft to transmit input power for conversion to electrical energy to alternators through transmission gear-shaft arrangements, has been shown.

FIG. 2: is the schematic illustration showing top view of the different elements of the said embodiment of the system for electrical power generation according to the present invention (as in FIG. 1).

FIG. 3(a): is the schematic line diagram illustrating the experimental trial of the device of the invention showing the incremental steps of radius of circular moving arms for the rotating moving machines to arrive at the preferred embodiment.

FIG. 3(b): is the schematic illustration of the circular moving tracks of the moving machines in incremental steps of radii/diameters of circular moving path of the moving machine around the central vertical shaft in an experimental trial according to an embodiment of the present invention.

FIG. 3(c): is the schematic illustration showing the most preferred radius/length of circular moving arm of the circular path the of the moving machines according to an embodiment of the invention, found by experimental trial.

FIG. 4: is the schematic illustration of the change gear arrangement in the speed control gear box showing the speed change gear teeth ratio corresponding to a preferred embodiment of the device according to the invention, determined through experimental trials, to obtain desired output speed of rotation of horizontal shaft connecting to the alternator/s.

### DETAILED DESCRIPTION OF THE INVENTION WITH REFERENCE TO THE ACCOMPANYING FIGURES

The present invention relates to a system for conversion of mechanical form of energy involving mass momentum or kinetic energy of moving bodies rotating through 360 degrees in circular path to be converted to electrical energy in small/large scale in simple, safe cost effective and eco-friendly manner without consuming any natural resource/fuel. The moving bodies according to a preferred embodiment in the present invention comprising moving machine such as two cars/trolley fitted with motor fitted at the end of an horizontal arm rotating about a vertical shaft mounted securely and freely on selective bearing housing wherein said rotation of vertical shaft along with a central crown operatively connected to alternators/generators at least at two and up to four (or more) locations, along the periphery of the circular path gear through reduction gear box and shaft for speed variation/increase and power transmission for desired electrical power generation.

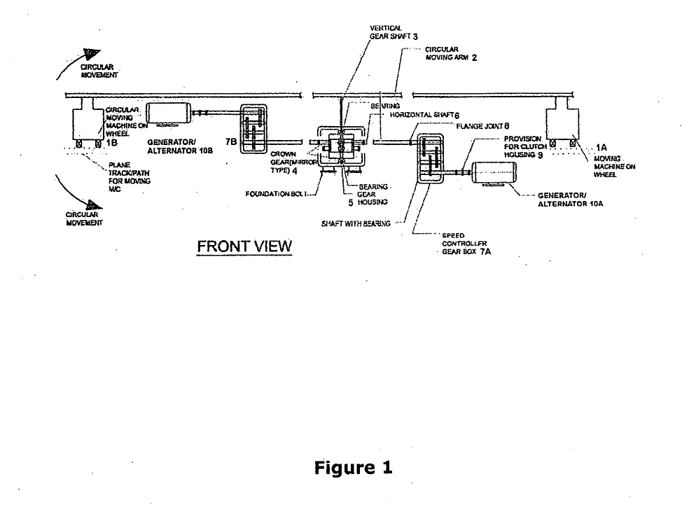

Reference is first invited to the accompanying FIG. 1 that schematically illustrate an embodiment of the system according to the present invention showing the front view of the system wherein the moving machine trolley/cars adapted to provide the required mass momentum or kinetic energy to a drive shaft to transmit input power for conversion to electrical energy to alternators through transmission gear-shaft arrangements, has been shown. It is clearly apparent from said FIG. 1 wherein the moving machine connected to the alternators comprising the following main components—(a) Moving machine comprising wheeled cars/trolleys (Item 1A & 1B) with drive motor and gear box adapted to receive power from external source or part of generation by the own system; (b) Horizontal Circular moving arm (Item 2); (c) Vertical gear shaft (Item 3); (d) Crown gear, (e) Gear housing (Item 5); (f) Horizontal shaft (Item 6); (g) Speed controller gear Box (Item 7); and (h) Generator/Alternator;

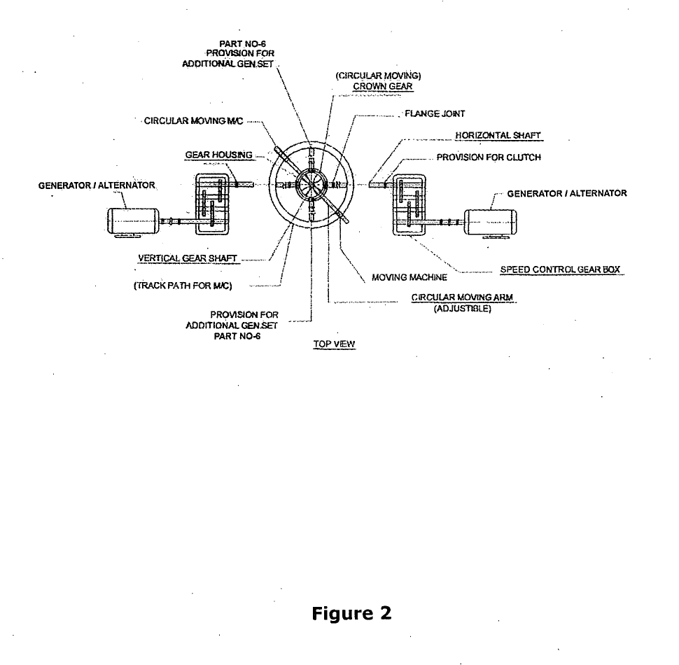

Reference is also invited to the accompanying FIG. 2 wherein all the above and other elements in the system with respective reference numerals have been shown in top view, that are arranged in desired combination to meet the desired end objective of generation of electrical power by conversion of mechanical energy of moving machines put into the system in the form of inertial mass momentum or kinetic energy.

Details of the constructional and functional features of the components of the system according to the present invention are as follows:

(a) The moving machines are the kind of vehicle/trolley etc. having motor, with gear box, steel wheel/tyres etc. The speed of the moving cars/trolleys can be adjusted to any desired value with the help of gear and move in circular track path at desired radius set with the help of its steering wheel/handle. When power is supplied to motor connected with gear and clutch of the trolleys, they start moving at 360° at required radius/circular path movement. The trolleys of the moving machine are connected with a horizontal arm (Item 2) in the system. The moving machine/trolley which move on wheel/tyres are fitted on either/both end of the horizontal moving arm supported with a vertical shaft at center. The trolleys moving on the circular path, rotate the horizontal arm through 360° either clockwise or anticlockwise as per convenience. Two or more moving machine can be put to operation with moving trolleys on both end of respective more than one horizontal rotating arms. The motor capacity/rating of cars/trolleys depend on capacity of alternator/generator. For starting the moving machine, first external power is provided in the form of electricity/energy from other sources, or can be manually also. Once operation start up connection will be switched off (of outer sources). After that it will run/operate with its own produced power.
(b) Horizontal arm connected with moving machine at its both end and center of the arm connected with main gear box of vertical shaft. It is made of any kind of metal having dimensions to ensure required strength and function. Its “Center” horizontally fixed on the top of vertical shaft (Item 3), of main gear box. It has one or two moving trolley/machine on its both end. Its length is adjustable. If we reduce its length we have to give more force to move it. If length is more, less force or power for moving (Item 3) would be required to provide required power to the vertical shaft and main gear drive systems. The system is also adapted to accommodate two or more arms in alternative embodiment.
(c) The vertical gear shaft is connected with big crown gear wheel or gear housing and shaft top head which is above the main gear box/gear housing and also with the horizontal moving/rotating arm (Item 2). The diameter of shaft may be different as per requirement depends on load and it can be made of any kind of metal or any size fitted/connected to main crown gear housing in vertical position and with bearings. When Item 2 moves, it moves freely by providing proper bearing in proper places.
(d) The crown gear (Item 4) is bigger in diameter having a ratio of 1:10 or more, as compared to other gear assembly in main gear housing and is fitted with bearing and chuck nuts. The vertical shaft with crown gear is supported on bearing, preferably cone bearing so that there occurs no tightness/center line out etc., at the time of operation and it rotates freely along with other meshing gears in the gear box. In alternative embodiments, there may be provided two crown gear wheel/gear wheel mirror type at a time, or only one depending on user requirement. When it rotates with vertical gear shaft (part no. 3), it gives rotation to its other connected smaller gear assembly in gear housing/main gear box (both are same) which in turn provide drive power to the alternators/generators in the system.
(e) Gear Housing (Item 5) is made from any metal and is of required size and shape e.g. round, square, hexagon etc., adapted to providing facility to put one, two and more horizontal shaft (Item 8), along with additional small speed controller gear boxes assembly (Items 7A & 7B) or more for alternator/generator used in higher numbers. With the gear housing will be fitted with foundation bolt. Its horizontal shaft will be fitted with part no. 7 with the help of flange.
(f) Horizontal shaft (Item 6) is provided coupled with flanges of the shaft of gear housing/main gear assembly shaft for two or more speed improver gear box assembly. Main Gear Box (Item 5) having facility for two or more horizontal gear shaft for more speed improver gear box one end connected with main gear box assembly shaft and 2^{nd} end connected with speed improver/controller gear assembly (Item 7A & b) by shafts as shown in the accompanying FIG. 2, clearly showing additional provision for more horizontal shafts. When main gear assembly start rotating this shafts automatically get rotational motion which is transmitted to the speed controller gear assembly (Item 7A & B). There is provided flange/coupling joints in between main gear box and speed controller gear boxes of corresponding horizontal shafts.
(g) Speed controller gear Boxes (Item 7A & B) is having connection with main gear box assembly (Item 5), with the help of required number of horizontal shafts (Item 6). This gearbox assembly and increase the low speed to higher speed, at the desired level required for connected alternator/generator/load etc. This gear box assembly having one of the gear shaft connected to the generator/alternator using coupling. This gear box assembly, vertically shaft, horizontal arm and moving machines are now interconnected with each other as well as the alternator/s/generator/s (Item 10). When moving machine/trolley start moving the, whole system gets rotational motion including the alternators via the gear boxes and connecting horizontal shafts to thereby producing desired electrical energy. When the whole system is operating, the alternator/generator (Item 10), start producing electricity.
(h) The Generators/Alternators (Item 10) in the present system is quite flexible in the sense that for generating electricity on a small scale, smaller size of equipment, machinery and generator are used of appropriate ratings and for higher electricity generation capacities the equipment, machinery and generator/alternator used are heavy duty. The machinery in the system configured accordingly in order that the system/method is very much capable to produce electricity from 1 KW to 60 MW and even more.

As already explained, the circular moving machine unit being operatively connected to a temporary power source for initial start up only. Said horizontal arm rotating substantially horizontally connected to the circular movement unit and vertical gear shaft of main gear housing. Main gear housing connected with another two or more gear boxes circular moving unit provide drive power to two or more Generator/Alternator at desired speed, so that any one or more alternators generate electrical power at the output. To start the moving machine/trolley power from any external source such as electrical power to a drive motor or fuel to a drive engine is supplied. After that a part of produced electricity from one of the connected generators/alternators supply power for its own use for moving machine/trolley motors and external start up sources/power is disconnected. Now, its operation will be continued till we want its production and when we cut up/switched off the moving car supply it will automatically stop.

The Main gear box is of shape such as round, square, hexagon etc. in such a way that it facilitate drive/rotation to two or more (say—2, 4, 6, 8 etc.) speed controller gear boxes, which are attached to at least two generator (even more) for producing the electricity. The system have been tried out using two generators, wherein power produced by one of the generator is used for the own system itself and balance production of another generator is connected to external load.

The main gear box having a vertical gear shaft connected with its big gear wheel/crown gear as well as with the horizontal arm. The big gear is connected to other small gear assembly, ratio of gear wheel 1:10 is sued in main gear box, which is depending on user's requirements. As the main gear wheel is rotated with vertical shaft due to rotation of the horizontal arm by the motion of the moving machine/trolley cars, it automatically rotate other connected gear assemblies at a relatively low speed. Main gear box with its gear assembly designed to accommodate two or four (4) horizontal driving shafts to be connected at a time or even more than that based on requirements of scale of operation. According to an embodiment of the invention there is provided to speed increasing/controlling gear boxes in the system, connected to the main gear bow with horizontal shafts. The second gear box is only for increasing the “required” speed for fitted with its alternator/Generator. When small gear assembly gets rotation from main gear assembly, it start to rotate. Two Alternators fitted with small gear shaft (placed on the opposite sides) with mirror type arrangement coupled through the speed controller gear boxes/assembly. The vertical shaft start rotating by moving machine/trolley providing rotary motion to the horizontal arm connected to it and this in turn provide required energy input to the Alternator/Generator operatively through the shaft main gear assembly, horizontal shafts and small speed controlling gear assembly such that the alternators start producing Electricity. Some of electricity generated by one of the alternator/generator is supplied to a switch through a cable lead to the connected trolley motor. When supply of its own generation is moving machine motor, its continuity is maintained and whole system will continue its work/operation. The we power connection is then switched off and its operation continues with its own produced power till required.

Main gear box is adapted to have more then one horizontal driving shaft (two, four and more) as per requirement, and thus more then two alternator/generator can be connected at a time to it, to produce electricity. Electricity may be supplied to the system/moving machine drive system for its own use from one of its alternator/generator and rest of other alternators production is supplied to external load. Function of the moving machine/trolley is based on the principle of mass momentum or kinetic energy as requirement of the system to produce electrical energy.

The above aspects and the functional features of the rotating moving machine device adapted to generate electricity by conversion of mechanical energy to electrical power is described in greater details with respect to following non limiting illustrative experimental trials/example:

### Example I

The moving machine either trolley with motor on track or tyre mounted vehicle on horizontal plane surface has been moved on different radii/diameters of moving path or the length of horizontal circular moving arm (Item 2), in incremental steps to study the performance of the system and to reach a most preferred arrangement for optimum performance and overall efficiency.

Step I:

Initially a radius of one meter or less has been adopted for the horizontal moving arm i.e. a diameter of 2 meters or less of the circular moving path for the moving machines. It is observed that larger force is required to move the trolleys/moving machine or more drive power is required to move them at required speed to provide the rotational motion to the vertical shaft. Another limitation was relating to insufficient space for installing and fittings of speed improve gear box to achieve desired output speed of rotation of horizontal shafts required for driving the alternators/Generator. Thus the first step of experimentation could not produce the desired result of conversion efficiency of the system according to the invention. The intention was to reduce the drive power requirement for the moving machine and increased output torque and speed for the vertical shaft as well as the horizontal shaft to drive the generators/alternators.

### Step II:

In the next step of experimentation, the length of the circular moving arm is increased up to 2.965 meters (approx) from center of vertical shaft to one end. The total length of arms on two sides i.e. the diameter of circular path of moving machine is 5.930 approx and circumference of 18.629 meters (approx). It is observed that the force and power requirement for moving the trolley as well as providing rotation to the vertical shaft reduced significantly and less force/power (5 HP to 10 HP) is required to provide rotation to the unit which is about 30% less than that when one meter length of arm was used.

### Step III:

In the next step of experimentation the length of circular moving arm is further increased to 6.635 meters (approx) from center of shaft to one end, i.e. total length is 6.635×2=13.270 meters in diameter of circular path. With this configuration, very less force is found to be required to move the trolley and the vertical shaft, as well as the whole system/unit required very less force. A 3 HP motor was mounted to drive one of the trolley at one end of the circular moving arm and it is found to be sufficient for the whole system to take the load of all components and gear arrangements. To achieve more speed of the “Moving Trolley” and thereby to maintain the required output R.P.M for generator/alternator (for maintaining the output R.P.M of 1500), the speed of motor is gradually increased with the help of “DRIVE SWITCH”. With this configuration, the moving machine run 4 times (four rounds along the circular path of the given diameter of 13.270 meters approx) around the unit in a minute i.e. to say one round in 15 second.

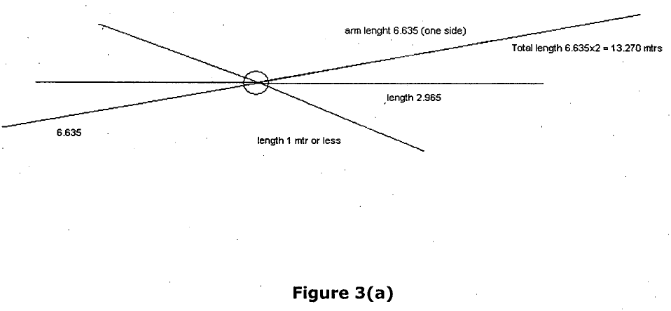

Accompanying FIGS. 3(a) to 3(c) illustrates the above experimental steps to achieve the most preferred length of the circular moving arm (Item 2) requiring much less input power to provide the rotational motion to the vertical shaft as well as the alternators (Item 10) via the operative connection to the horizontal shaft (Item 6) through speed control gear box arrangement (Item 7).

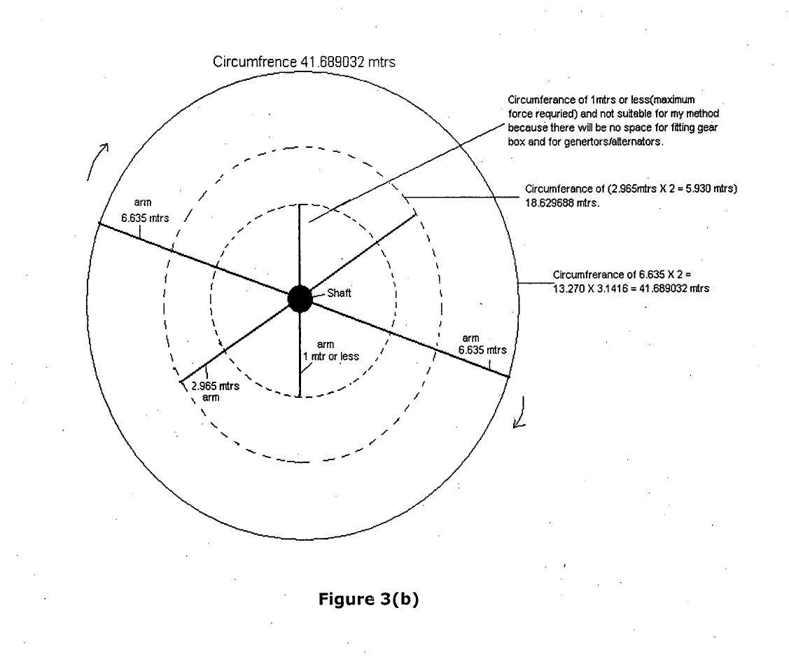

It is also found that for one rotation of the vertical gear shaft (Item 3) attached to main gear box, provides 6.85 rotation at the output, which is the input to another speed improve gear box assembly (Item 7) that further improves the speed to the alternator shaft. The accompanying FIG. 4 illustrates schematically the speed improved achieved by a gear arrangement in the control gear box having gears with specified number of gear teeth to maintain desired speed ratio.

Thus the resultant output rotation for the embodiment as shown ensure a rotational speed of 428.982 at alternator and corresponding to 3.75 rotation of moving trolley or shaft in a minute, a RPM of 1608.683 (i.e. above the desired value of 1500 RPM) is achieved at the alternator shaft. The speed of trolley can be well controlled with the help of “Drive Switch” and thus controlling the rotation of the shaft, so that even if the speed is reduced due to the force by friction of gear and wheel, bearings etc, the actual required speed/rotation for generators is still maintained. According to a preferred embodiment as of the present invention, two alternators/generators with capacity of 7.5 K.W each are operated for a rated output of 15 K.W. When a 3 H.P or 5 H.P motor is used to drive the trolleys/moving machines of the system, 100% of production of one generator is saved for use by output load and another 20% to 30% generation of the 2^{nd} generator is also saved, while only about 80% of power generated by one alternator is consumed by the system itself to drive the trolley motor. Hence, in all 7.5 kW from one alternator and another plus 3.75 kW from the other alternator (120% of total installed generation capacity) is available from the system without the usage of any conventional raw material and without any pollution. According to alternative embodiments, the system is adapted to provide connection to increased number of generator/alternators through additional horizontal shaft and speed control gear box in different symmetric angular positions disposed along the periphery of the main central crown gear.

It is thus possible by way of the present invention to provide a system to produce electrical energy by the conversion of mechanical energy of moving machine/mass momentum or kinetic energy of moving bodies. The system provides means for simple, safe, less costly and reliable operation to generate electricity with less operational and initial costs, reduced maintenance and longer life, The system is having flexibility to be scaled-up to suit small or large capacity producing 1 kW to up to 6 MW in a environment-friendly manner, requiring less space and less time for installation and starting of operation. The present system using mechanical form of energy to be converted to much desired electrical energy for domestic or industrial and other consumers, is adapted for wide scale application with significant cost advantage.

1-23. (canceled)

24. A system for generation of electricity by conversion of mechanical or other form of energy, said system comprising:
at least one rotatable circular moving machine connected with at least one rotatable circular moving arm, wherein said circular moving arm is supported with respect to a vertical gear shaft positioned in a bearing gear housing, wherein two ends of said moving arm are adapted to be freely rotated in a circular path causing rotation of said vertical shaft;
at least one alternator(s)/generator(s) operatively connected to said vertical shaft, wherein rotation of said vertical shaft allows said alternator/generator to generate electricity.

25. The system of claim 24, wherein said system further comprises at least one speed-improving gear means operatively connected to said vertical shaft and said alternator/generator, wherein said at least one speed-improving gear means controls speed of said vertical shaft and amount of electricity produced.

26. The system of claim 24, wherein said rotatable circular moving arm has adjustable length to operate said alternator/generator of variable capacity.

27. The system of claim 24, wherein said moving arm is operatively adapted at its free ends with said moving machine, wherein said moving machine provides kinetic energy to drive said vertical gear shaft to transmit input power for conversion to electrical energy through said alternator/generator.

28. The system of claim 24, wherein said moving machine comprises a drive motor and a gear box adapted to receive power from an external source or from electricity generated by said alternator/generator.

29. The system of claim 24, wherein said system further comprises at least one crown gear assembly and at least one horizontal shaft operatively coupled with said vertical gear shaft and said alternator/generator, wherein said at least one horizontal shaft connects said vertical gear shaft to said at least one speed-improving gear means.

30. The system of claim 24, wherein said moving machine comprises of one or more of a wheeled car, and a trolley having a means for controlling speed of said moving machine.

31. The system of claim 24, wherein said moving machine moves on the circular path rotating said moving arm through 360° either clockwise or anticlockwise.

32. The system of claim 24, wherein said system comprises of at least two said alternator(s)/generator(s), further wherein one of said at least two alternator(s)/generator(s) is used for running said moving machine and other said alternator(s)/generator(s) are used for generating electricity for external purposes.

33. The system of claim 24, wherein said system comprises of at least two said moving machines operatively connected to said vertical gear shaft through at least two said moving arms, further wherein said at least two said moving machines are positioned diagonally opposite to each other.

34. The system of claim 24, wherein said bearing gear housing is of desired shape and size selected from round, square, hexagon and configured based on one or more of desired electricity to be generated, number of gears, and number of said alternator(s)/generator(s).

35. A method for production of electricity without usage of any raw materials, said method comprising:
connecting a rotation enabling mechanism to a vertical gear shaft by means of a moving arm;
circularly rotating said moving arm through said rotation enabling mechanism causing rotation of said vertical gear shaft;
connecting said vertical gear shaft to a generator/alternator through a bearing gear box to generate electricity.

36. The method of claim 35, wherein said rotation enabling mechanism is based on magnetic force used for creating kinetic energy.

37. The method of claim 35, wherein said rotation enabling mechanism is a fan used for creating kinetic energy.

38. The method of claim 35, wherein said rotation enabling mechanism is a moving machine selected from one or more of a car, and a trolley.
